(19) United States
(12) Patent Application Publication
(10) Pub. No.: US 2021/0105954 A1
(43) Pub. Date: Apr. 15, 2021

(54) Multi-Tiered Wall Planter

(71) Applicant: George M. Cardenas, Seal Beach, CA (US)

(72) Inventor: George M. Cardenas, Seal Beach, CA (US)

(21) Appl. No.: 16/601,105

(22) Filed: Oct. 14, 2019

(51) Int. Cl. A01G 9/02; A01G 27/00

(52) U.S. Cl. CPC A01G 9/025; A01G 9/023; A01G 27/005

(57) ABSTRACT

A wall-mounted planter apparatus incorporates a housing with a container storage allowing multiple removable containers to be positioned on cleats within the housing. The apparatus employs gravity to equally distribute a volume of fluid to the removable containers through an irrigation assembly. The irrigation assembly couples to the rear of the housing and incorporates a top-positioned reservoir and vertical channels, portions of which couple to emitter cavities of the housing and facilitate flow through individual apertures of the emitter cavities. The diameter of the apertures is calculated based on each apertures' vertical distance from the reservoir. The removable container can also be reoriented to manipulate plant growth and manage reservoir resources. Additionally, a lid configured to cover the removable container and foster, e.g., ideal germination conditions, can also be used a drip tray if the removable container is removed from the housing and used separately as a planter.

### FIELD OF TECHNOLOGY

This disclosure relates generally to wall-mounted indoor planters and, more particularly, to a vertical multi-tiered planter housing with gravity flow irrigation, load spreading, moisture containment, and a modular container thereof.

### BACKGROUND

The majority of in-home plant containment structures involve a pot resting on a surface, hanging from a fixture, or mounted to a wall. Most current solutions for vertically oriented plant containers occupy vast real estate, rely on regular user irrigation with a drip pan and/or require electromechanical irrigation implements.

For example, U.S. Patent Pub. No. 20110258925 (hereinafter “Baker”) describes a “Vertical Planter” in which plants are irrigated via a drip irrigation tube fed from a main water supply tube and pump. In another example, U.S. Pat. No. 5,438,797 (hereinafter “Lendel”) describes a “Vertical Planter” comprised of a series of individual pots centered about a pole attached to a support base. Each pot and plants therein are irrigated with fluid via a tubing system located inside the pole support structure and emitters located in each pot at each tier. The system uses a pump to force fluids through the tubes. Complex plumbing solutions requiring pressure and tubing systems must be regularly maintained and/or filtered and depend on a power source. At the very least, requiring electricity can be a large barrier to entry for most users seeking simple solutions for maximizing wall space utility. Furthermore, these planters introduce excessive risk—a pump running dry may burn out, a loss of power can leave plants dry, leaky plumbing can cause mold and mildew damage to underlying drywall or wood substrates.

In another example, U.S. Pat. No. 8,689,485 (hereinafter “Friedman”) describes a “Vertical Planter and Gardening Wall” comprised of interlocking, stackable planter blocks. These planter blocks stack by nesting bilateral protrusions thereof which allow excess water to drain to underlying blocks. However, even a minor façade assembled as a cluster of blocks would require disassembly to gain meaningful access to the growing medium, e.g., to add compost, reseed, fertilize. Furthermore, the irregular shape demanded by Friedman's structural requirement makes it difficult to mount to a wall. At least a majority of the blocks in a façade would need to be fixed to the wall, providing major installation impediments for the basic user.

Most wall-mounted objects are unitary structures fastened to a wall anchor or a stud. However, the weight of plant containment structures can fluctuate dramatically in the short-term (e.g., due to irrigation, soil amendments) and in the long term (i.e., due to plant growth). Concentrated masses can cause excessive torque which can damage wall anchors or cause the planter to lean and collapse. Current solutions may be used to spread the load on anchors on the wall, but mounting structures alone do not employ reliable means of spreading the load of the planter.

Thus, a need exists for a wall-mounted, gravity flow-irrigated planter structure that incorporates a modular approach to plant containment, allows water loads to be spread within the structure, and can easily be installed and maintained by the average end user.

### SUMMARY

Various aspects of a planter apparatus have been claimed. One aspect involves a housing which incorporates a container storage with at least one pair of opposing cleats integrated into the housing. The cleats are configured to hold one or more removable containers. The housing is mountable to a vertical surface via a hanging cleat affixed to a rear surface of the housing. One or more emitter cavities protrude from a surface of the container storage, each emitter cavity comprising an orifice configured to direct a fluid. Additionally, the apparatus involves an irrigation assembly coupled to the housing which includes a fluid reservoir positioned above the container storage and one or more channels coupled to the fluid reservoir. The one or more channels are configured to distribute a volume of fluid from the fluid reservoir to the one or more removable containers through the one or more emitter cavities.

Another aspect of the planter apparatus involves a manifold which physically incorporates a beveled front edge creating a first front surface and a second front surface. The first front surface and the second front surface allow the manifold to rest in one of many orientations and may be referred to as resting surfaces. The manifold also incorporates a bottom surface and an air channel thereof. The air channel is a raised portion of the bottom surface which separates a lower section of the manifold into one or more reservoirs. The air channel comprises a first plurality of apertures that allow air circulation and provide a drainage pathway to prevent roots around the one or more reservoirs from being overflowed.

In yet another aspect, a planter system involves a housing comprising a container storage. The container storage provides a plurality of tiered container storage spaces, each tiered container storage space comprising a pair of opposing cleats integrated into opposite sides of a recessed portion of the housing. The housing also utilizes a hanging cleat affixed to a rear surface of the housing and a basin disposed below the container storage area. Additionally, one or more emitter cavities protrude from a surface of the container storage and each emitter cavity has an orifice configured to direct a flow of fluid.

The planter system also incorporates one or more removable containers, each container comprising a manifold. Each manifold provides a plurality of resting surfaces at different angles which allow the removable containers to be placed within the housing in a plurality of orientations. Each manifold also incorporates a plurality of reservoirs which are separated by one or more air channels protruding from a bottom surface of the manifold.

The one or more removable containers are gravity-fed a fluid through an irrigation assembly coupled to the housing from a fluid reservoir positioned above the container storage. The irrigation assembly utilizes one or more channels coupled to the fluid reservoir to equally distribute a volume of fluid from the fluid reservoir to the removable container(s) through the orifice(s) of the one or more emitter cavities.

### BRIEF DESCRIPTION OF THE DRAWINGS

The embodiments of this invention are illustrated by way of example and not limited by the figures of the accompanying drawings, in which like references indicate similar elements and in which:

FIG. 1A is a front perspective view of an exemplary planter housing, according to one or more embodiments.

FIG. 1B is a rear perspective of the planter housing of FIG. 1A showing an exemplary gravity-flow irrigation manifold, according to one or more embodiments.

FIG. 2A is a schematic drawing of an exemplary planter housing and methods of inserting a container therein, according to one or more embodiments.

FIG. 2B shows a cross-section of a container insert, according to one or more embodiments.

FIG. 2C shows a perspective view of the cross-section of FIG. 2B, according to one or more embodiments.

FIG. 3 is a perspective view of an exemplary container insert and lid, according to one or more embodiments.

FIG. 4 is a rear perspective view showing separation of the irrigation assembly from the housing, according to one or more embodiments.

FIG. 5 is a schematic showing a cross section of an emitter cavity fed water by the irrigation manifold, according to one or more embodiments.

Other features of the present embodiments will be apparent from the accompanying drawings and from the detailed description that follows.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. As such, such details are meant to be interpreted in an illustrative, not a restrictive, sense.

Various embodiments of a modular, wall-mounted planter housing (hereinafter “wall planter”) are provided herein. The wall planter facilitates cultivation of edible and non-edible plants indoors or outdoors in many types of grow media and makes efficient use of wall space without compromising on moisture retention or risking wall damage.

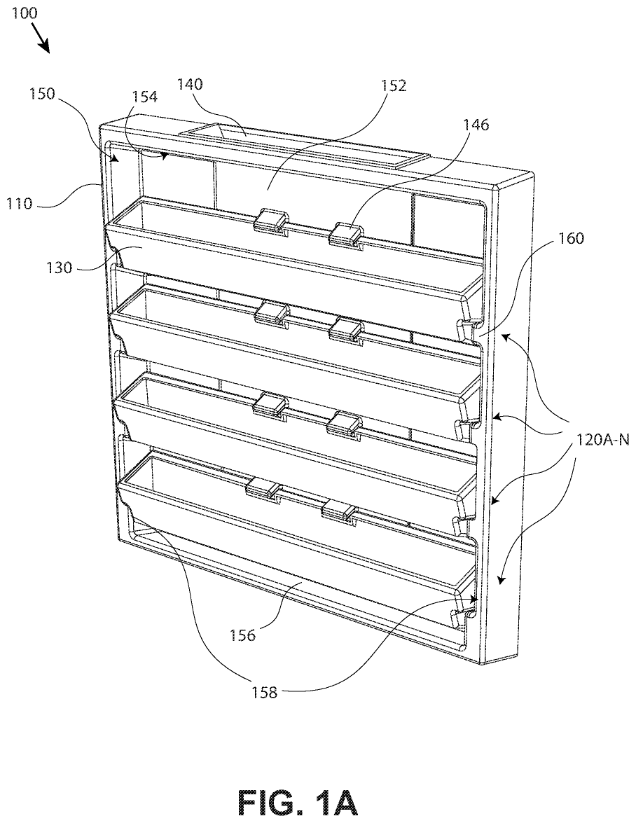

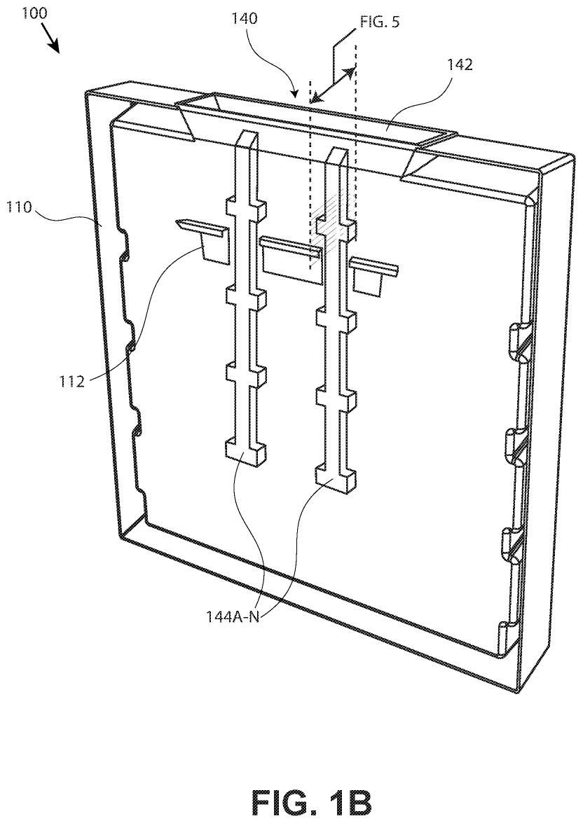

Referring to FIG. 1A, a front perspective view of a wall planter 100 is shown, according to one or more embodiments. The wall planter 100 may be made of any appropriate structural material(s); for example, the wall planter 100 may be molded from non-toxic, recyclable acrylonitrile-butadiene-styrene (ABS) or polyvinyl chloride (PVC) plastics. In another example, the wall planter 100 may be made of wood, concrete, or high-density polyethylene (HDPE) resin. The wall planter 100 may comprise a housing 110 having one or more tiers 120A-N in which a removable container 130 can be positioned and oriented. Each tier may be individually irrigated by an integral irrigation manifold. Although the wall planter 100 can incorporate any number of tiers 120A-N holding any number of removable containers 130 of any size and shape, it may be preferred to size the removable containers 130 according to a number of factors, such as desired surface area for plant growth, maximum weight limit, limited wall space, etc. In some preferred embodiments, a wall planter with two or four tiers accommodates containers that provide similar total surface area and biomass to standard flat sizes available in nurseries. Additionally, the integral irrigation manifold and all pathways therein are expected to readily facilitate the flow of water or any other fluid or solution (such as a mixture of water and water-soluble plant fertilizers).

Referring additionally to FIG. 1B, a rear perspective view of the wall planter 100 shows an exemplary gravity flow irrigation assembly 140. The irrigation assembly 140 comprises a reservoir 142 integrated into the housing 110 above the tier(s) 120A-N and one or more irrigation channels 144A-N leading from the reservoir 142 and terminating in one or more emitter(s) 146 at each tier. The emitters 146 may individually comprise apertures of calculated diameter to ensure an even distribution of water from the reservoir 140 to each of the emitters 146.

The housing 110 may conform to one or more particular shapes depending on the desired form factor in the immediate environment and/or due to manufacturing constraints. Additionally, the housing 110 is meant to provide a rigid structure that may be mountable to a wall or fixture, may contain the removable containers 130 in one or more configurations, may accommodate the constituents of the water delivery system (i.e., the reservoir 140, the one or more irrigation channels 144A-N), and may evenly distribute water received through the water delivery system.

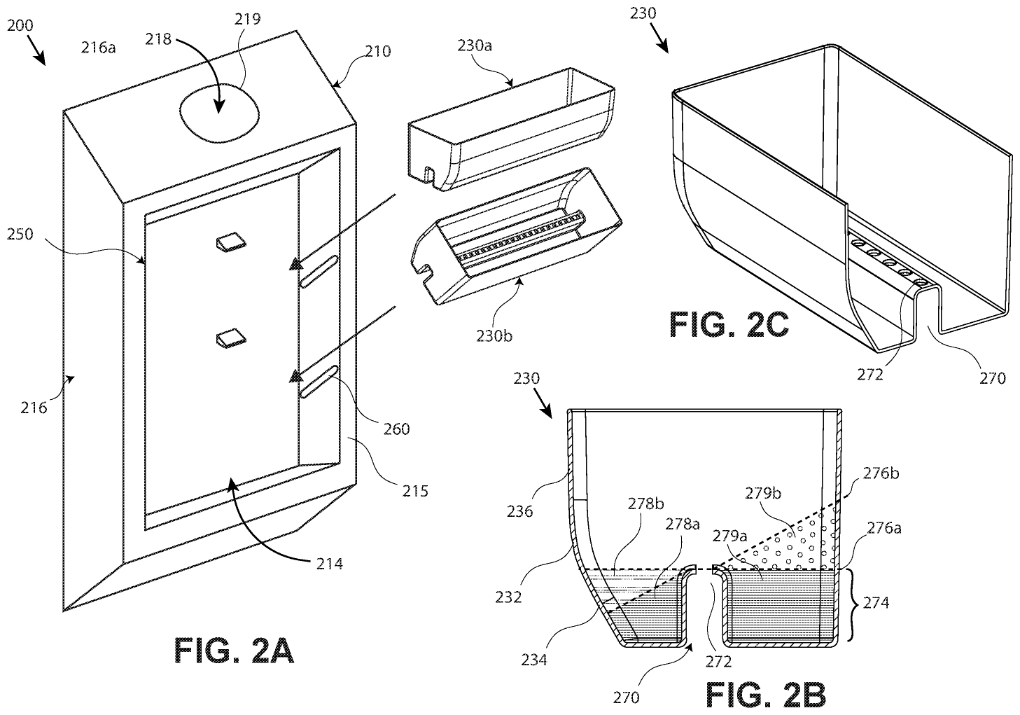

Structurally, the housing 110 may be a molded manifold and may at least comprise a frontal recess 150 with five inner surfaces: a front-facing surface 152, a top surface 154, a bottom surface 156, and lateral surfaces 158. The lateral surfaces 158 may comprise protruding rails 160 which may provide resting positions for the removable containers 130. In one embodiment, the protruding rails 160 may be angled upward as shown, providing a pair of hanging cleats which actively prevent a placed container 130 from dropping out of the housing 110 because the protruding rail 160 is oriented at an angle of depression from a perpendicular line extending from the front-facing surface 152. This is further explored in FIG. 2A.

The rear portion of the front-facing surface 152 may comprise a hanging cleat 112. When incorporated with the irrigation channels 144A-N, the hanging cleat 112 may be split to allow the hanging cleat 112 to optimally distribute the load of the housing 110. The hanging cleat 112 may rest on a complementary mounting cleat affixed to, e.g., a wall.

Referring to FIG. 2A, a schematic drawing of an exemplary wall planter 200 showing methods of inserting a removable container 230 therein is illustrated.

The housing 210 may comprise a container storage 214, which may comprise a recessed portion of a front surface 215 of the housing 210. Outer walls 216 may protrude rearward from the edge of the front surface 215 and extend past the rear of the container storage 214, creating an air gap which allows the irrigation assembly to fit onto the rear of the housing and still provide space between the irrigation assembly and the wall. Additionally, the air gap drastically limits the extent to which excess water contacts the surface the housing is affixed to.

The outer walls 216 may also comprise a top surface 216a that is angled upwards to provide a cavity 218 between the top surface 216a and the recessed portion of the container storage 214. A fluid reservoir may be positioned within said cavity 218 and an aperture 219 of the top surface 216a may be positioned above the water reservoir to allow a user to fill the water reservoir.

Referring additionally to FIGS. 2B-2C a front section view and a perspective section view are shown, respectively. In one or more embodiments, the removable container 230 may conform to a particular shape to accommodate a diverse set of features. In one embodiment, the removable container 230 may comprise a beveled front edge 232, causing the volume of the lower half of the removable container 230 to be cut somewhat in order to provide an angled surface 234. The shallow angle of the beveled front edge 232 allows the removable container to more easily be removed from an injection mold. Additionally, other edges and corners of the removable container 230 may be beveled, chamfered, or filleted to improve manufacturability.

The angled surface 234 may allow the removable container 230 to be more easily restrained in the housing 210 by the protruding rails 260. The angle of the protruding rails 260 may match that of the angled surface 234, allowing the removable container 230 to be placed in an upright orientation 230a. The angled surface 234 also serves to promote the growth of the plants in the container below by providing more unhindered and un-scattered light. Additionally, the angled surface 234 allows the removable container 230 to be flipped and placed into the housing 210 in an alternate orientation 230b that allows the top of the removable container 230 to point away from the housing instead of purely vertical.

The removable container 230 also comprises a rear surface 238 which is flat and is meant to rest against the protruding rails 260 in the alternate orientation 230b, which may be achieved by resting the rear surface 238 of the removable container 230 on the protruding rails 260, i.e., by rotating the removable container 230 180° within a horizontal plane, pitching the removable container 230 down and placing the rear surface 238 on the protruding rails 260. Additionally, the angled surface 234 rests against the front-facing surface of the housing 210. This alternate orientation 230b allows plant matter growing in the removable container 230 to be more easily trained to exploit the space around the housing 210, especially when there is a suitable light source in proximity and adequate air circulation. Exploiting gravitropism and phototropism in this way allows the wall planter to be used to generate considerable vertical or viny growth.

The removable container 230 may also comprise a convex protrusion 270 incorporating a series of apertures 272 on the top edge and protruding from the base of the removable container 230 to a height 274. Fluid remaining in the removable container 230 may rest within one or more reservoirs 278a-b and 279a-b separated by the convex protrusion 270. The different portions of the reservoirs 278a-b and 279a-b may be utilized differently according to the orientation of the removable container 230, e.g., in the upright position 230a, the reservoirs 278a-b and 279a are utilized. It will be appreciated that although different shading has been provided to show the volume of fluids in the reservoirs 278a-b and 279a-b, the fluid therein may be the same, different, or the reservoirs 278a-b and 279a-b may be empty. It will also be appreciated that although reservoirs 278a-b and 279a-b are shown, other reservoirs and portions thereof may be created by different configurations of the convex protrusion 270.

The convex protrusion 270 facilitates drainage and provides greater surfaces area for root aeration in the removable container 230. Excess moisture from the reservoirs 278a-b and 279a-b may escape through the apertures 272 to the container below. The apertures 272 are placed at a position 276 along the convex protrusion 270, the lowest of which also marks a top level 276a-b of the fluid in the reservoirs 278a-b and 279a-b. Furthermore, the volume of the reservoirs 278a-b are further limited by the angled surface 234, which can prevent the prevalence of root rot and other diseases caused by excess moisture. Furthermore, improved air flow afforded by the apertures 272 may prevent environmental conditions that would cause mold and rot to form on roots (i.e., low oxygen, high moisture, high temperature).

When the removable container is in orientation 230b, the convex protrusion 270 is tilted forward. Plants in either position tend to grow outward from the housing 210, but in orientation 230b, the convex protrusion 270 provides an anchor for plant roots that gives mechanically advantageous support as plant matter continues to grow outward from the housing 210. Additionally, the tilted removable container 230b trades reservoir 278b to stores additional water in larger reservoir 279b situated behind the rear surface 238. Even though root growth in this context may be submerged in water in this cavity, the apertures 272 of the convex protrusion provide ample air exchange for the roots and prevent root and mold. Additionally, it is preferred to place the removable container 230 in a drafty environment to discourage mold growth.

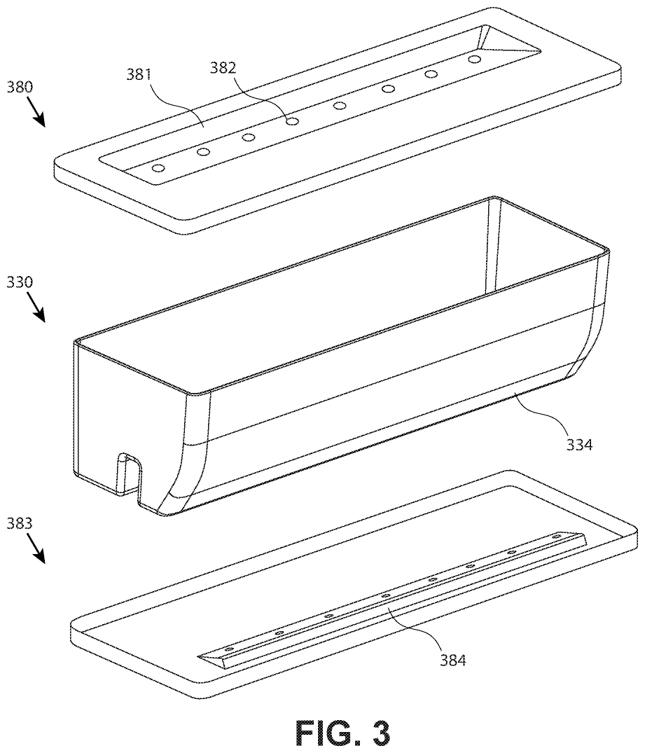

Referring to FIG. 3, a perspective view of the removable container 330 is shown with an exemplary lid 380. In one or more embodiments, the lid may be used to cover the removable container 330 (e.g., to enhance germination conditions) or may be inverted to be used as a drip tray (i.e., if the container is used outside of the housing 210). The lid 380 may comprise a sloped groove 381 which protrudes superficially into the container 330 when the lid 380 is placed thereon. The sloped groove 381 may comprise a series of apertures 382, which is analogous to the apertures 272 of the convex protrusion 270, i.e., they provide air flow, allow excess drainage to continue to the container below, and prevent adverse conditions for plant growth from taking place. Typically, the lid 380 may be used to enhance germination conditions by locking in some heat and moisture but providing adequate air flow for initial plant growth through the apertures 272.

Conversely, the lid 380 may be flipped and used as a drip tray 383 as shown in FIG. 3. Since the apertures 380 may be at the suspended above the bottom of the tray 383, there would be little risk of leakage. The sloped groove 381 flipped may be a convex protrusion 384 which provides a support for the angled surface 334 and can keep the container 380 propped up when used outside of the housing 210.

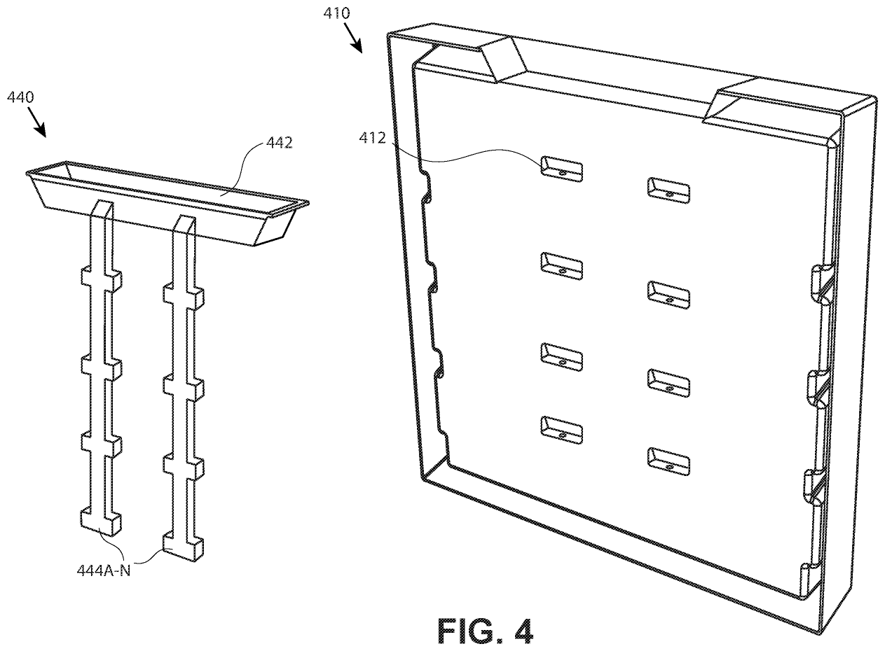

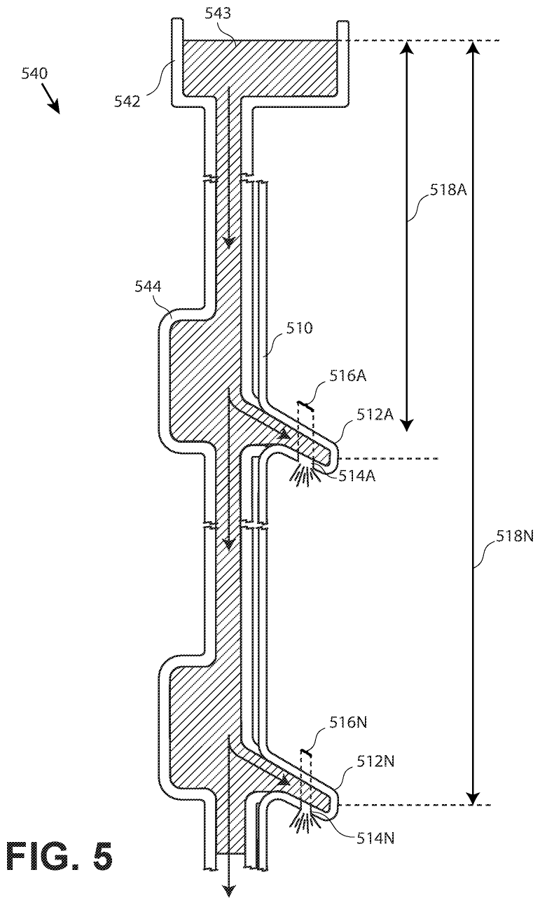

Referring to FIG. 4, a rear perspective view of the wall planter shows the housing 410 separated from the irrigation assembly 440. The rear surface of the housing 410 may be opposite to the front-facing surface of the frontal recess 150 may comprise a plurality of emitter cavities 412 which may deliver water received by the irrigation channels 144A-N. The irrigation channels 144A-N may comprise portions which fit within the emitter cavities 412 as described in FIG. 5. All joined members between the housing 410 and the irrigation assembly 440 may be tightly fit together and glued to ensure a leakproof seal.

Referring to FIG. 5, a schematic diagram shows a cross-section of the emitter cavities 512A-N of a wall planter being fed water 543 by a reservoir 542 of the irrigation assembly 540. The irrigation assembly 540 utilizes gravity to feed water to the emitter cavities 512A-N. Each of the emitter cavities 512A-N comprises an orifice 514A-N having a diameter 516A-N, the size of which changes based on the tier. In the case of multiple vertically aligned orifices, the diameter of each of the orifices must be specifically machined to provide enough backpres sure in the irrigation channel 544 such that an equal distribution of water is delivered to each tier during a watering session without disruption. Disrupting the flow may cause irregular flow or dribbling. To further prevent dribbling, the emitter cavity may be entirely angled downwards to prevent water cohesion from causing water emitted from the orifice from clinging to and traveling alongside the surface of the housing 510. However, even if some dribbling may cause water to travel alongside the surface of the housing 510, the water may be directed outwards again as it travels around the next emitter cavity, and especially if it meets the stream being emitted by the orifice of the next emitter cavity.

Liquid volume flow can be determined by using the below formulas:

V=C_{d}A\sqrt{2gH},

Where V is equal to the volume (in m³/s), C_{d} is a discharge coefficient, A is the area of the orifice (m²), g is gravitational acceleration (9.81 m/s²), H is the distance between the orifice and the top of the water level in the reservoir 542, and

C_{d}=C_{c}Cᵥ,

where C_{c} is a contraction coefficient and Cᵥ is a velocity coefficient of water, which is 0.97. C_{c} is characterized by the orifice edge shape and/or contour. Generally, a sharpened edge-aperture may exhibit a C_{c} of approximately 0.62 whereas a well-rounded aperture correlates with a C_{c} of about 0.97.

As long as the cross-sectional area of the irrigation channel 544 is larger compared to that of the orifices 514A-N, losses to friction may be negligible. In other words, the width of the irrigation channel 544 should not be exceeded by the diameters 516A-N. More broadly, the cross-sectional area of the irrigation channel 544 must be greater than the area of the orifices 514A-N. Furthermore, additional room may be provided by the irrigation channel 544 around the emitter cavities 512A-N, as shown in FIG. 5. This extension may create intermediate reservoirs along the vertical length of the irrigation assembly 540, further stabilizing a flow of water exiting through the orifices 514A-N.

In a preferred embodiment, each removable container may receive the same or approximately the same volume of water. This is achieved by gradually decreasing the diameter 516A-N of the orifices 514A-N as the distance 518A-N between the orifices and the top of the water reservoir 542 increases. In testing environments, the orifices 514A-N were positioned at distances 518A-N (i.e., H) of approximately 4.5 inches, 9.75 inches, 12.25 inches, and 19.75 inches from the top of the water 543 level in the reservoir 542. The diameters 516A-N of the orifices 514A-N were approximately 5/52″, 3/41″, 1/16″, and 5/91″, respectively. Using an approximately 40 in³ reservoir 542 and around 726.15 mL of water 543, the tiers drained in approximately 24.1s, 26.6s, 29s, and 32.1s, from top to bottom.

In a sample embodiment, the wall planter may comprise four tiers accommodating four removable containers. The irrigation assembly may provide two irrigation channels (more than one channel may be needed for wider containers), each providing water to emitters in vertical columns. Although vertical alignment is not absolutely necessary, it vastly reduces complications in volume flow management and improves irrigation consistency. The cross-sectional dimensions of the irrigation channel were 0.5″×0.25″, which causes water traveling through the irrigation channels to be at lower velocity compared to that exiting the orifices.

What is claimed is:

1. A planter apparatus mountable to a wall comprising:
a housing comprising:
a container storage with at least one pair of opposing cleats integrated into the housing,
wherein the cleats are configured to hold one or more removable containers,
wherein the housing is mountable to a vertical surface via a hanging cleat affixed to a rear surface of the housing;
one or more emitter cavities protruding from a surface of the container storage, each emitter cavity comprising an orifice configured to direct a fluid; and
an irrigation assembly coupled to the housing, comprising:
a fluid reservoir positioned above the container storage;
one or more channels coupled to the fluid reservoir, wherein the one or more channels are configured to distribute a volume of fluid from the fluid reservoir to the one or more removable containers through the one or more emitter cavities.

2. The apparatus of claim 1, wherein the container storage is a recessed portion of a front surface of the housing, and the housing comprises an outer wall extending rearward from the outer edge of the front surface to the wall and only to an extent necessary to create an air gap between the rear surface of the housing and the wall.

3. The apparatus of claim 1, wherein a diameter of each orifice(s) is inversely proportional to a distance between the orifice and a top level of fluid in the reservoir.

4. The apparatus of claim 1, wherein the housing further comprises a basin disposed below the container storage and configured to catch excess fluid.

5. The apparatus of claim 1, wherein a cross-sectional area of the one or more channels does not exceed a sum of the areas of each orifice of the one or more emitter cavities.

6. A removable container apparatus comprising:
a manifold comprising:
a beveled front edge creating a first front surface and a second front surface,
wherein the first front surface and the second front surface allow the manifold to rest in multiple orientations,
a bottom surface and an air channel thereof,
wherein the air channel is a raised portion of the bottom surface which separates a lower section of the manifold into one or more reservoirs,
wherein the air channel comprises a first plurality of apertures that allow air circulation and provide a drainage pathway to prevent roots around the one or more reservoirs from being overflowed.

7. The removable container apparatus of claim 2, further comprising:
a lid configured to cover the removable container, comprising:
a top surface having one or more depressions containing a second plurality of apertures,
wherein a flow of fluid entering the one or more depressions exits through the second plurality of apertures, and
wherein the second plurality of apertures provide adequate air flow for preventing unfavorable germination conditions.

8. The container apparatus of claim 6, wherein in one orientation, the manifold rests on its bottom surface and beveled front edge.

9. The container apparatus of claim 6, wherein in one orientation, the manifold rests on a rear surface of the manifold, causing the manifold to tilt and cause the air channel to be oriented at an angle conducive to supporting the plant roots of plant matter growing out of the removable container at the angle.

10. The container apparatus of claim 7, wherein the plurality of apertures are positioned along the one or more depressions such that when the lid is utilized top surface-down as a tray beneath the manifold, a flow of fluid from the manifold entering the tray remains in the tray and does not drain through the second plurality of apertures.

11. A planter system mountable to a wall, comprising:
a housing comprising:
a container storage having a plurality of tiered container storage spaces, each tiered container storage space comprising a pair of opposing cleats integrated into opposite sides of a recessed portion of the housing;
a hanging cleat affixed to a rear surface of the housing;
a basin disposed below the container storage area;
one or more emitter cavities protruding from a surface of the container storage, each emitter cavity comprising an orifice configured to direct a flow of fluid; and
one or more removable containers, each container comprising a manifold having:
a plurality of resting surfaces at different angles allowing the removable containers to be placed within the housing in a plurality of orientations;
a plurality of reservoirs separated by one or more air channels protruding from a bottom surface of the manifold;
an irrigation assembly coupled to the housing comprising:
a fluid reservoir positioned above the container storage; and
one or more channels coupled to the fluid reservoir and configured to equally distribute a volume of fluid from the fluid reservoir to the removable container(s) through the orifice(s) of the one or more emitter cavities.

12. The system of claim 11, wherein the container storage is a recessed portion of a front surface of the housing, and the housing comprises an outer wall extending rearward from the outer edge of the front surface to the wall and only to an extent necessary to create an air gap between the rear surface of the housing and the wall.

13. The apparatus of claim 11, wherein a diameter of each orifice(s) is inversely proportional to a distance between the orifice and a top level of fluid in the reservoir.

14. The apparatus of claim 11, wherein the housing further comprises a basin disposed below the container storage and configured to catch excess fluid.

15. The apparatus of claim 11, wherein a cross-sectional area of the one or more channels does not exceed a sum of the areas of each orifice of the one or more emitter cavities.

16. The apparatus of claim 11, wherein the removable container further comprises:
a lid configured to cover the removable container, comprising:
a top surface having one or more depressions containing a second plurality of apertures,
wherein a flow of fluid entering the one or more depressions exits through the second plurality of apertures, and
wherein the second plurality of apertures provide adequate air flow for preventing unfavorable germination conditions.

17. The container apparatus of claim 11, wherein in one orientation, the manifold rests on the opposing cleats using its bottom surface and a front resting surface.

18. The container apparatus of claim 11, wherein in one orientation, a rear resting surface of the manifold sits on the opposing cleats and an angled front surface is positioned against the surface of the container storage, causing the manifold to tilt and cause the air channel to be oriented at an angle conducive to supporting the plant roots of plant matter growing out of the removable container at the angle.

19. The container apparatus of claim 16, wherein the second plurality of apertures are positioned along the one or more depressions such that when the lid is utilized top surface-down as a tray beneath the manifold, a flow of fluid from the manifold entering the tray remains in the tray and does not drain through the second plurality of apertures.
